(19) United States
(12) Patent Application Publication
(10) Pub. No.: US 2002/0129783 A1
(43) Pub. Date: Sep. 19, 2002

(54) Cylinder block assembly with lubricating fluid reservoir

(76) Inventor: Howard J. Lawrence, Southampton (GB)

Correspondence Address: CATERPILLAR INC., 100 N.E. ADAMS STREET, PATENT DEPT., PEORIA, IL, 616296490

(21) Appl. No.: 10/097,732

(22) Filed: Mar. 14, 2002

(30) Foreign Application Priority Data
Mar. 16, 2001 (GB) 0106514.3

(51) Int. Cl. F02F 7/00

(52) U.S. Cl. 123/195 C

(57) ABSTRACT

A cylinder block assembly for an internal combustion engine comprises a cylinder block and a crankcase housing in the cylinder block. The cylinder block assembly includes an apron sealably mounted on a surface of the cylinder block and a fluid reservoir defined between the apron and the crankcase housing for receiving lubricating fluid. The fluid reservoir is communicable with the crankcase housing and serves as an engine lubricant capacitor to increase the lubricant capacity of the engine.

### TECHNICAL FIELD

This invention relates to a cylinder block having an increased engine oil capacity and to an internal combustion engine including the cylinder block. The invention also relates to a method for lubricating an engine.

### BACKGROUND

During operation of an engine, a lubricant such as engine oil is pumped from a sump into the working portions of an engine in order to lubricate, clean and cool the engine's moving parts. Excess oil supplied to the moving parts is drained back to the sump along various paths defined in the engine cylinder block and cylinder head.

A large volume of lubricating oil is desirable in an engine. For example, where the volume of engine oil is increased, degradation of the oil volume will be slower, therefore service intervals can be increased to minimize maintenance costs. The acceptable level of degradation is governed largely by the level of carbon contamination and it has been found desirable to limit this contamination to a maximum of 2%.

However, the volume of oil which can be employed in an engine is limited by engine size as, in general, it is desirable to maintain the engine envelope size at a minimum whereas large volumes of oil require large storage reservoirs in an engine. It may be particularly desirable to minimize any sideways or downward extension of the engine sump since the sump is frequently close to fouling engagement with vehicle cross-members, steering linkages, etc.

UK Patent Specification No 1499588 describes an internal combustion engine having a lateral oil reservoir fitted alongside the crankcase which replaces the conventional oil sump. During operation, oil is pumped from the reservoir to a lubricating system and from a base of the crankcase back to the reservoir. While the absence of a conventional oil sump underneath the crankcase provides good ground clearance, the position of the reservoir necessitates the use of an additional pump to return oil from the crankcase to the reservoir. Further, the narrow and elongated shape of the reservoir, added to the velocity of the oil through the reservoir, tend to inhibit or slow passage of gases from the oil to an engine breather system.

The present invention is directed to solving one or more of the problems set forth above.

### SUMMARY OF THE INVENTION

In accordance with one aspect of this invention, a cylinder block assembly comprises a cylinder block, a lubricating fluid sump, a crankcase housing in the cylinder block, and an aperture in the crankcase housing. An apron is sealably mountable on the cylinder block, and a fluid reservoir is defined between the apron and the crankcase housing. The fluid reservoir is adapted to receive lubricating fluid, and the fluid reservoir is communicable with the crankcase housing through the aperture.

In accordance with another aspect of this invention, an engine comprises a cylinder block, a lubricating fluid sump, and a crankcase housing, the crankcase housing being formed in the cylinder block. An apron is sealably mounted on the cylinder block, and a fluid reservoir is defined between the apron and the crankcase housing. A fluid passage extends between the reservoir and the crankcase housing.

According to another aspect of this invention, a method is provided for lubricating an engine of the type comprising a cylinder block, a lubricating fluid sump, an apron sealably mounted on the cylinder block; and a lubricating fluid reservoir defined between the cylinder block and the apron. The method includes the step of supplementing a level of lubricating fluid in the sump with lubricating fluid from the reservoir.

### BRIEF DESCRIPTION OF THE DRAWINGS

Various embodiments of the invention will now be described, by way of example only, having regard to the accompanying diagrammatic drawings in which:

FIG. 1 is an isometric view of an engine including a cylinder block assembly in accordance with the invention made up of an apron mounted on a cylinder block with a portion of the apron cut-away to reveal the cylinder block side wall;

FIG. 2 is an isometric view of the engine of FIG. 1 with the apron removed; and

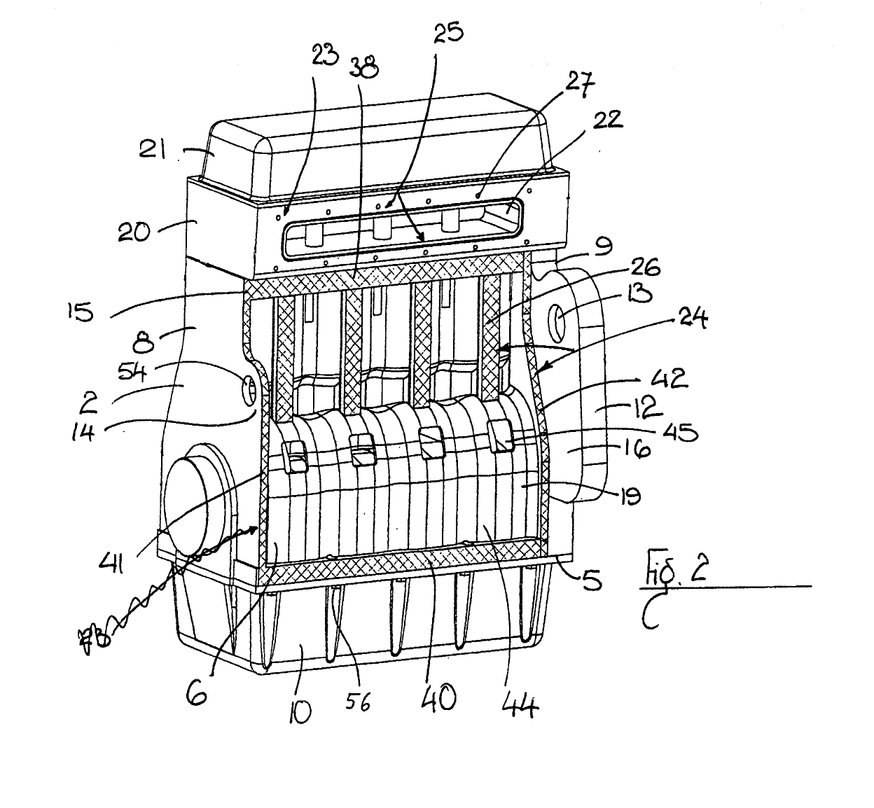

FIG. 3 is a schematic cross-sectional end view of the engine of FIGS. 1 and 2 relating to further embodiments of the invention to include heat exchange elements located on an external face of the apron and alternative attachment means for attaching the apron to a cylinder head and a sump.

### DETAILED DESCRIPTION

As shown in the drawings, a cylinder block apron in accordance with the invention is a generally tray-like apron 1 sealably mountable on and cooperable with a cylinder block 2 which is adapted to receive the apron 1 in a fluid tight relationship. The apron 1 sealably encloses engine oil and crankcase gases to provide a fluid reservoir 11 between the apron 1 and the cylinder block 2 thereby acting as an engine oil capacitor.

The cylinder block 2 shown in the Figures is a cast cylinder block having a flanged cylinder block base 5. The cylinder block 2 includes a cylinder block first side wall 6, a cylinder block second side wall 7 substantially parallel with the cylinder block first side wall 6, a cylinder block front end wall 8 and a cylinder block rear end wall 9 all upstanding from the cylinder block base 5. In the present example, the first side wall 6 is substantially non-machined, so that it is substantially free of tapped bosses, machined faces, extended structures and other features normally required to secure ancillary engine components to the cylinder block 2.

The cylinder block 2 is provided with a cylinder head 20 fitted with a cylinder head cover 21. The cylinder head 20 is provided with an integral air inlet manifold 22.

The side walls 6, 7 are shaped to define a crankcase housing 19 adjacent the cylinder block base 5 for housing a crankcase 44. The side wall 6 is provided with passages in the form of cylinder block draining holes 17 to facilitate oil drainage from cylinder head drainage holes 18 in the cylinder head 20. A sump 10 abuts the cylinder block base 5.

The cylinder block rear end wall 9 is provided with a rear bearing plate 12 which projects laterally outwards from the first side wall 6. The bearing plate 12 has an inner face 16 disposed towards the cylinder block first side wall 6. The rear bearing plate 12 is provided with a bore to receive engine ancillary components. Similarly, the front end wall 8 is provided with a front bearing plate 14 which projects laterally outwards from the first side wall 6. The bearing plate 14 is provided with a mounting bore 54. The front end wall 8 projects laterally outwardly from the second side wall 7.

The cylinder block 2 and the cylinder head 20 are provided with attachment points for facilitating attachment of the structural apron 1. More particularly, the cylinder block 2 is provided with adhesive sealant attachment points 24 and mechanical attachment points 25 as will be described later, while the cylinder head 20 is provided only with mechanical attachment points 25 in order to facilitate any required subsequent removal of the cylinder head 20 from the cylinder block 2 and apron 1. Although the Figures show the attachment of the apron 1 to the side walls, 6, 7, it is to be understood that the apron may be attached to any suitable surface or combination of surfaces of the cylinder block 2.

The adhesive sealant attachment points 24 are made up of a sealant receiving border 15 defined on the periphery of the first side wall 6. The sealant receiving border 15 is substantially quadrilateral in shape and extends around a perimeter defined by a top outer edge 38 on the side wall 6 adjacent the cylinder head 20, a bottom outer edge 40 of the side wall 6 adjacent the cylinder block base 5, an outside edge 41 of the front bearing plate 14 and an end edge 42 adjacent the rear bearing plate 12. The sealant receiving border 15 forms a mating surface and is adapted to receive an adhesive sealant 43 between the cylinder block 2 and the apron 1 to define the fluid reservoir 11. The apron 1 has a mating surface which corresponds to the mating surface of the receiving border 15. The sealant 43 is applied between the mating surfaces and serves to ensure that the fluid reservoir 11 is fluid tight and is able to hold lubricating fluid such as oil.

The adhesive sealant attachment points 24 are also made up of adhesive sealant receiving ribs 26 formed on the side wall 6 of the cylinder block 2 for receiving adhesive sealant to adhesively secure the apron 1 to the side wall 6. The ribs 26 extend vertically upwards from the crankcase housing 19 to the top outer edge 38 of the side wall 6.

Preferably, the cylinder head 20 has threaded holes 27 surrounding the inlet manifold 22. The threaded holes 27 are adapted to receive fasteners to mechanically secure the apron 1 to the cylinder head 20.

As indicated above, the apron 1 is substantially tray-like in shape. The apron 1 is formed from a sheet metal material or other suitable material shaped or configured so that the apron 1 is adapted to sealably attach to the side wall 6 of cylinder block 2 to define the fluid reservoir 11 therebetween. Each side wall 6, 7 can be provided with an apron 1 if desired.

The apron 1 is dimensioned according to the dimensions of the cylinder block 2. For example, the apron 1 is dimensioned to fit between the rear bearing plate 12 and the front bearing plate 14 and between the cylinder block base 5 and cylinder head 20 on the side wall 6.

The apron 1 is made up of a bottom portion 29, a central cylinder block portion 30 and a top cylinder head portion 31.

The bottom portion 29 of the apron 1 is folded to define an elongate beam 32 having a box-like cross section. The box-like elongate beam 32 is therefore made up of a beam bottom wall 33 having elongate first and second beam side walls 34, 35 respectively upstanding therefrom. The box-like beam 32 is further provided with a beam top wall 36 extending between the first and second beam side walls 34, 35 respectively.

The beam bottom wall 33 is provided with a series of spaced apart beam attachment holes 37 to facilitate attachment of the apron 1 to the sump 10.

The elongate beam 32 provides additional and efficient stiffness to an assembled engine structure while the box-like construction serves as a chassis rail and provides stiffened engine mounting locations.

The central cylinder block portion 30 is contiguous with the apron bottom portion 29 and is shaped and folded to abut the side wall 6 at the adhesive sealant receiving border 15 and to define the reservoir 11 between the apron 1 and the cylinder block 2.

The central cylinder block portion 30 of the apron 1 is made up of an upstanding panel 39 which is adapted to abut the ribs 26 on the cylinder block 2 to sealably secure the apron 1 to the ribs 26.

The top cylinder head portion 31 is made up of an upright cylinder head panel 46 contiguous with the upstanding panel 39. The cylinder head panel 46, like the upstanding panel 39, is disposed in a substantially upright disposition and is shaped at its free end to define an elongate top rail 47. The top rail 47 projects outwardly away from the cylinder head 20.

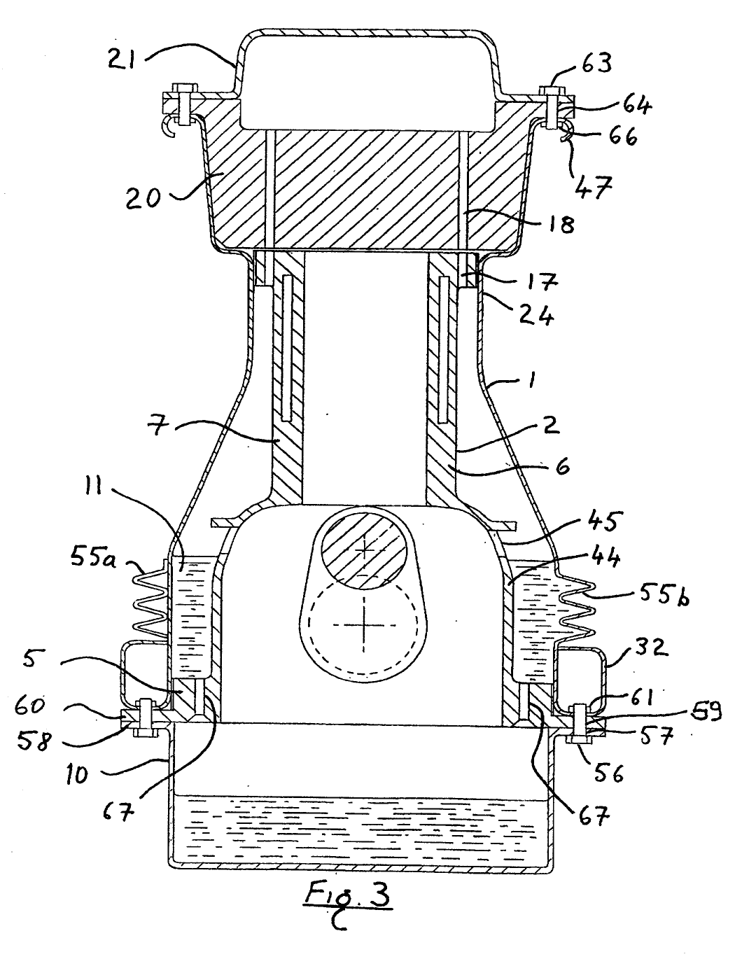

The top rail 47 provides additional stiffness to an assembled engine structure while in an alternative embodiment also serving to attach the apron 1 to the cylinder head 20. In a still further embodiment, with particular reference to FIG. 3, the top rail 47 can also be adapted to be fastened to the cylinder head cover 21 if required.

The cylinder head panel 46 has a top series of spaced apart mounting holes 48 located adjacent the top rail 47 and a bottom series of spaced apart mounting holes 49. The top series of mounting holes 48 and the bottom series of mounting holes 49 are adapted to receive fasteners for securing the cylinder head panel 46 to the cylinder head 20.

The cylinder head panel 46 has an aperture 50 to facilitate communication between an elbow connector 51 engageable with the aperture 50 and the air inlet manifold 22 within the cylinder head 20.

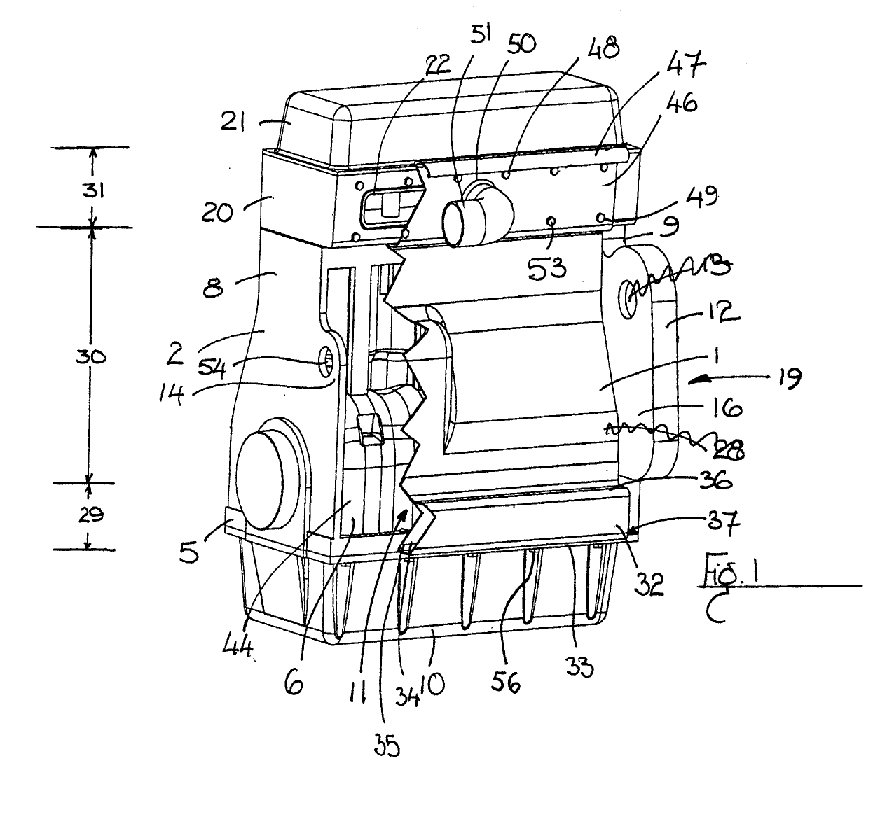

As shown in FIG. 1, the apron 1 is mounted on the cylinder block first side wall 6. However, it will be appreciated that a suitably shaped apron 1 can alternatively or additionally be mounted on the second side wall 7.

The apron 1 is fastened to the side wall 6 by fasteners 56 inserted through holes 57 in a flange 58 of the sump 10, through corresponding holes 59 in a flange 60 of the cylinder block 2 and hence into threaded holes 61 in the beam bottom wall 33. The fasteners 56 also thus secure the sump 10 to the apron 1 and hold the sump 10 tightly against the cylinder block base 5.

The fasteners 56 also facilitate the attachment of an optional sump guard to the apron 1 if required.

The apron 1 is fastened to the cylinder head 20 by fasteners 53 inserted through the mounting holes 48, 49 of the cylinder head panel 46 into the corresponding threaded holes 27 in the cylinder head 20.

In a further embodiment, with particular reference to FIG. 3, the apron 1 may be fastened to the cylinder head 20 by fasteners 63 inserted through a series of spaced apart mounting holes 64 in a flange 65 of cylinder head 20 and into corresponding threaded holes 66 formed in the top rail 47. The fasteners 63 may optionally also secure cylinder head cover 21 as shown in the figure.

The fasteners 53, 56, 63 can be any suitable fasteners such as threaded screws or studs and nuts. Threaded holes 61, 66 can be formed by any conventional means such as weld nuts, rivet nuts, edge clips and the like. Alternatively, threaded holes 61, 66 can be formed by the “Flowform” (Trade Mark) process in which a hole is pierced in apron 1 and thread-rolled. Alternatively further, fasteners 56, 63 may be weld studs, self-tapping screws, rivets or the like, in which case the holes 61, 66 will not need to be pre-threaded.

As previously described, attachment of the apron 1 to the cylinder block 2 is via the adhesive sealant receiving border 15 and the adhesive sealant receiving ribs 26. Suitably, a sealing adhesive could be applied by a robot applicator or screen printing of the adhesive on to the apron 1.

Fluid is received into the reservoir 11 through the draining holes 17 in the side wall 6 which facilitate fluid communication between the reservoir 11 and the cylinder head 20. Fluid from the reservoir 11 is returnable to the crankcase 44 through return apertures 45 in the crankcase housing 19 which facilitate communication between the reservoir 11 and the crankcase housing 19.

Accordingly, the reservoir 11 serves as an oil capacitor to supplement the oil sump 10. The reservoir 11 fills from the draining holes until the oil level is level with the return apertures 45 whereupon the overflow oil is returned via the apertures 45 in the crankcase 44 to the sump 10. Holes 67 in the cylinder block base 5 facilitate a controlled flow of oil from the reservoir 11 to the sump 10, thus ensuring, firstly, movement of the whole volume of oil through the engine filtration and lubrication system and, secondly, providing a reservoir oil drain means during engine servicing.

FIG. 3 further shows an alternative embodiment of an apron 1 of the invention mounted on a cylinder block 2. The apron 1 is broadly similar to the apron 1 previously described, accordingly like numerals indicate like parts. The apron 1 is mounted on the side wall 6 of the cylinder block 2. However, in the present embodiment, the apron 1 is provided on its outer surface with one or more cooling elements in the form of heat exchanging baffles 55a, 55b extending laterally outwards from the apron 1 at the central cylinder block portion 30 to facilitate cooling of engine oil contained within the reservoir 11 between the apron 1 and the cylinder block 2. The baffles 55a, 55b therefore contribute to convective cooling of oil within the reservoir 11.

The reservoir 11 also allows de-aeration of oil and gases in an engine due to the increased capacity and also promotes condensation of gases.

The cooling element may be attached to the apron 1 as separate baffles 55a or integrally formed baffles 55b which are part of the apron 1. Thus, the cooling element may be fluidly isolated from the reservoir 11 or may be fluidly connected to the reservoir. Where the cooling element is fluidly connected to the reservoir 11 (see baffles 55b), improved oil cooling efficiency and an increase in the oil capacity of the reservoir may be expected. The triangular prismatic outer shape of the baffles is helpful in avoiding the retention of ambient foreign matter which would reduce thermal transfer efficiency.

The apron 1 may include provision for mounting engine ancillaries and accessories. Examples of such engine accessories and auxiliary components include, but are not limited to: engine electronic control units and wiring harnesses, clips and ties; low pressure fuel system components such as lift pumps, filters, pipes; high pressure fuel systems including fuel injection pump support brackets; lubrication system components including remote filter mountings, electric oil pumps, hose attachments and closed circuit breather system components; cooling system components including electrical cooling pumps, mechanical cooling pumps, hose attachments, heat exchangers for oil and EGR systems and fan mountings; ancillary drives including brackets and attachments for alternators, PAS pumps, vacuum pumps, compressors, air conditioning pumps, idler pulleys, tensioners and other driven accessories; air system components including air ducts and trunking, inlet manifolds and elbows, inlet air heat exchangers, exhaust mountings, TC oil drain supports and the like; emissions system components including mountings for closed coupled after-treatment devices and EGR components; engine mounting parts; transmission mounting parts.

In the given example, apron 1 is envisaged as having a thickness of from about 2 to about 4 millimeters but thickness selection will need to take into account variables such as the required stiffness, ease of forming and the duty to which the apron is to be subjected to, as well as any accessories to be mounted thereon and whether engine mountings and transmission housings are to be attached thereto. The apron 1 may be reinforced locally as required. The apron can be flat folded and bent or pressed to shape as required.

The apron 1 can be formed from high strength low alloy (HSLA) steel but can also be formed from cold rolled mild steel, aluminum sheet or any other material having suitable characteristics. The apron 1 can be configured by, for example, laser machining or the like or may be numerically controlled punch profiled. The apron 1 may be folded by a brake press and deep drawn for pressed features.

In an alternative embodiment of the invention, the apron 1 can be provided with front and/or rear flanges (not shown) to assist in fixing the apron 1 to the front wall 8 or rear end wall 9 of the cylinder block 2. Where the cylinder block 2 is provided with two aprons 1, flanges from one of the aprons 1 can be extended to join with the opposite side apron 1 to provide an additional area for attachment of fan mountings and the like.

The apron 1 may be provided with a color scheme as required thereby dispensing with or reducing the requirement to paint engine cylinder blocks and the like following manufacture. An advantage of employing a color is that the paint finish quality may be easily controlled, for example by using epoxy paints. Moreover, pre-painted aprons can also be employed with cylinder blocks 2 while aprons 1 formed from sheet steel can be readily plated for show or special finishes e.g. infra-red absorption, zinc, chromium, gold and the like. Moreover, anodized aluminum finishes can also be employed.

The apron 1 also serves to provide a surface for printing corporate identification, end user identification and other use instructions on an engine employing screen-printing techniques and the like. Alternatively, the apron 1 serves to provide a good surface for application of adhesive labels and the like to an engine.

### Industrial Applicability

The apron 1 of the invention encloses engine oil and crankcase gases and functions, in combination with the cylinder block 2, to provide a fluid reservoir which serves as an engine oil capacitor to provide extended engine service intervals. Oil within the reservoir 11 is also convectively cooled.

As the reservoir does not replace, but is provided in addition to, the sump, a conventional oil pumping system may be utilized to circulate oil around the engine. Further, as the oil feed from the reservoir to the sump, via the crankcase, is generally provided by a weir arrangement, no further pumps are required.

The velocity of the oil during engine operation is slowed during its passage through the reservoir. Accordingly, crankcase gases and other gases are able to release from the relatively tranquil oil in the reservoir 11 and pass upwards into an engine breather system that will conventionally be provided at a relatively high point in the engine.

The apron 1 of the invention also results in lower manufacturing costs for cylinder blocks 2, and in particular for cylinder blocks 2 requiring customization, as side wall machining of the cylinder blocks 2 to receive engine auxiliary components is reduced or eliminated. The aprons 1 therefore facilitate enhanced flexibility in cylinder block design and manufacture. Moreover, the apron 1 of the invention results in lower noise and vibration in engines fitted with the apron 1.

The cylinder block 2 and the cylinder head are provided with draining holes 17, 18 which allow oil drain and crankcase gas interchange with the cylinder head 20.

The apron 1 also facilitates the reduction or elimination of tapped bosses and machined faces on the sides of the cylinder block 2. The cylinder block 2 can therefore be designed for minimal machining operations while extended structures normally needed to attach engine auxiliary components can also be dispensed with. The apron 1 can be employed with short block, deep skirt or ladder constructions of cylinder block while the cylinder block can be formed, in conventional manner, from cast iron or aluminum or other suitable material. The apron 1 can also facilitate engine transport and handling. For example, the elongate beam 32 may be adapted for engagement with forklift truck tines.

As indicated above, the apron 1 can be attached to the cylinder head 20 employing low cost sheet metal fastening methods such as the Flowform (Trade Mark) process, weld nuts and studs, rivet nuts, self-tapping screws, rivets, edge clips and the like.

The apron 1 can be pre-assembled with some engine auxiliary components in order to further increase engine manufacture efficiency. Such components may include electronics control units, harnesses, pipes, brackets etc which can be pre-assembled with the apron 1 as a sub-assembly on a side feeder to a main assembly line. It will be appreciated by those skilled in the art that shorter main assembly lines serve to reduce work in progress and provide greater flexibility and reduced costs.

The apron 1 mounted on a cylinder block 2 provides additional structural stiffness to increase natural bending/torsion frequencies and thereby reduce transmitted noise and vibration to permit optimal mounting designs.

The apron 1 provides application design flexibility and facilitates customization of an engine. For example, aprons 1 manufactured on adaptable numerically controlled laser profilers, punches and brake presses may be easily customized to customize the cylinder block 2. Such equipment could be located close to an assembly line to provide late specification flexible manufacture of cylinder blocks to provide a means for satisfying customer specific requirements without excessive tooling costs or disruption to base engine production. In effect, engine mountings may be located at a desired location on the apron 1 as required without significant additional costs.

The invention is not limited to the embodiments herein described which can be varied in construction and detail.

What is claimed is:

1. A cylinder block assembly comprising:
a cylinder block;
a lubricating fluid sump;
a crankcase housing in the cylinder block;
an aperture in the crankcase housing;
an apron sealably mountable on the cylinder block, and
a fluid reservoir defined between the apron and the crankcase housing, said fluid reservoir being adapted to receive lubricating fluid, said fluid reservoir being communicable with the crankcase housing through the aperture.

2. A cylinder block assembly as set forth in claim 1 wherein the cylinder block assembly includes a cylinder head mounted on the cylinder block, said cylinder block having at least one passage communicable with the reservoir.

3. A cylinder block assembly as set forth in claim 1 wherein the apron includes an outer surface, said outer surface having at least one cooling element adapted to cool the fluid reservoir.

4. A cylinder block assembly as set forth in claim 3 wherein the cooling element comprises a baffle integrally formed in the apron.

5. A cylinder block assembly as set forth in claim 1 further including a fluid passage extending between the reservoir and the sump, which fluid passage is dimensioned to effect a controlled flow of lubricating fluid from the reservoir to the sump.

6. A cylinder block assembly as set forth in claim 3 further including a fluid passage extending between the reservoir and the sump, which fluid passage is dimensioned to effect a controlled flow of lubricating fluid from the reservoir to the sump.

7. A cylinder block assembly as set forth in claim 1 wherein the side wall is substantially non-machined.

8. A cylinder block assembly as set forth in claim 4 wherein the side wall is substantially non-machined.

9. A cylinder block assembly as set forth in claim 5 wherein the side wall is substantially non-machined.

10. A cylinder block assembly as set forth in claim 1 wherein the cylinder block assembly includes a cylinder head mounted on the cylinder block and wherein the apron includes mechanical attachment points adapted to attach the apron to the cylinder head.

11. An engine, comprising:
a cylinder block assembly as set forth in claim 1; and
a cylinder head mounted t o said cylinder block assembly.

12. An engine comprising:
a cylinder block;
a lubricating fluid sump;
a crankcase housing, said crankcase housing being formed in the cylinder block;
an apron, said apron being sealably mounted on the cylinder block;
a fluid reservoir, said fluid reservoir being defined between the apron and the crankcase housing; and
a fluid passage, said fluid passage extending between the reservoir and the crankcase housing.

13. A method for lubricating an engine of the type comprising a cylinder block, a lubricating fluid sump, an apron sealably mounted on the cylinder block; and a lubricating fluid reservoir defined between the cylinder block and the apron, the method including the step of supplementing a level of lubricating fluid in the sump with lubricating fluid from the reservoir.

14. A method as set forth in claim 13 further comprising the step of cooling lubricating fluid in the reservoir by causing the fluid to contact cooling baffles formed in the apron.

15. A method as set forth in claim 13 wherein said supplementing step includes causing lubricating fluid to flow from the reservoir to the sump through a passage, wherein the passage is dimensioned to effect a controlled flow of lubricating fluid from the reservoir to the sump

16. A method as set forth in claim 14 wherein said supplementing step includes causing lubricating fluid to flow from the reservoir to the sump through a passage, wherein the passage is dimensioned to effect a controlled flow of lubricating fluid from the reservoir to the sump.
